(19) United States
(12) Patent Application Publication
(10) Pub. No.: US 2024/0168278 A1
(43) Pub. Date: May 23, 2024

(54) LIGHT SOURCE DEVICE AND IMAGE DISPLAY DEVICE

(71) Applicant: SONY SEMICONDUCTOR SOLUTIONS CORPORATION, KANAGAWA (JP)

(72) Inventor: KENTARO HARASE, KANAGAWA (JP)

(21) Appl. No.: 18/549,947

(22) PCT Filed: Jan. 24, 2022
(86) PCT No.: PCT/JP2022/002391

§ 371 Date: Sep. 11, 2023

(30) Foreign Application Priority Data
Mar. 22, 2021 (JP) 2021-047198

(51) Int. Cl. G02B 25/00; G02B 5/32

(52) U.S. Cl. CPC G02B 25/001; G02B 5/32

(57) ABSTRACT

Provided is a light source device and an image display device for providing a high-resolution image while enlarging an eye-box, and contributing to downsizing of the device. The present technology provides a light source device including at least a projection optical system configured to branch light emitted from a light source unit into light in a plurality of directions and emit the light, in which the projection optical system emits the light in the plurality of directions toward an eyepiece optical unit configured to receive light emitted from the projection optical system and emit the light to a retina of a user. Light in at least two directions among the light in the plurality of directions emitted from the projection optical system may be emitted to the same retina.

### TECHNICAL FIELD

The present technology relates to a light source device and an image display device.

### BACKGROUND ART

Conventionally, a technology for allowing a user to visually recognize an image by projecting image light onto a retina of the user has been used. In use of the technology, in order to project the image light onto the retina of the user, a convergence point of the image light is preferably located on a pupil of the user.

However, there is a problem that a human pupil is very narrow, and it is difficult to adjust a projection position of light due to movement of an eyeball, positional deviation of an eyepiece lens that projects image light to the pupil of the user, and the like.

In order to solve this problem, for example, Patent Document 1 and the like disclose a technology of arranging a diffractive element on an optical path between a light source that projects image light and an eyepiece lens. This technology achieves enlargement of an eye-box. The eye-box refers to a position of a pupil at which an image is properly viewed.

### CITATION LIST

### Patent Document

Patent Document 1: International Publication No. 97/37339

### SUMMARY OF THE INVENTION

### Problems to be Solved by the Invention

However, in the technology using a diffractive element, there is a problem that a resolution of an image is lowered due to an influence of an optical loss caused by generation of scattered light. Furthermore, since there is a limit to an angle at which the diffractive element can diffract, there is also a problem that downsizing of a device becomes difficult.

Therefore, a main object of the present technology is to provide a light source device and an image display device for providing a high-resolution image while enlarging an eye-box, and contributing to downsizing of the device.

### Solutions to Problems

The present technology provides a light source device including at least a projection optical system configured to branch light emitted from a light source unit into light in a plurality of directions and emit the light, in which the projection optical system emits the light in the plurality of directions toward an eyepiece optical unit configured to receive light emitted from the projection optical system and emit the light to a retina of a user.

Light in at least two directions among the light in the plurality of directions emitted from the projection optical system may be emitted to the same retina.

The projection optical system may have: a light branching unit configured to branch light emitted from the light source unit into light in a plurality of directions; and a light reflecting unit configured to reflect light in at least one direction among the light in the plurality of directions branched by the light branching unit.

The light branching unit may have a half mirror.

The projection optical system may have a prism.

The projection optical system may have a plurality of light branching units.

The projection optical system may have a plurality of light branching units and a plurality of light reflecting units.

The light reflecting unit may have an angular characteristic in which image light reflected by the light reflecting unit is not emitted to the light branching unit.

The projection optical system may further have an optical path length correction unit configured to correct an optical path length.

Furthermore, the present technology provides an image display device including: the light source device; and an eyepiece optical unit configured to receive light emitted from the light source device and emit the light to a retina of a user.

The eyepiece optical unit may have a holographic optical element lens.

The light source device may be disposed in a direction inclined with respect to a normal direction of a surface of the holographic optical element lens.

The projection optical system may further have a distortion correction unit configured to correct distortion of an image.

The distortion correction unit may have a curved mirror.

The distortion correction unit may have a free-form surface lens.

### BRIEF DESCRIPTION OF DRAWINGS

FIG. 1 is a schematic top view illustrating a configuration of a light source device 10 according to an embodiment of the present technology.

FIG. 2 is a schematic top view illustrating an optical path in the vicinity of an eyepiece optical unit 20 according to an embodiment of the present technology.

FIG. 3 is a schematic top view illustrating a configuration of the light source device 10 according to an embodiment of the present technology.

FIG. 4 is a schematic top view illustrating a configuration of the light source device 10 according to an embodiment of the present technology.

FIG. 5 is a schematic top view illustrating a configuration of the light source device 10 according to an embodiment of the present technology.

FIG. 6 is a schematic top view illustrating a configuration of an image display device according to a comparative example of the present technology.

FIG. 7 is a schematic top view illustrating a configuration of the light source device 10 according to an embodiment of the present technology.

FIG. 8 is a schematic perspective view illustrating a usage example of an image display device 100 according to an embodiment of the present technology.

FIG. 9 is a schematic top view illustrating a configuration of the image display device 100 according to an embodiment of the present technology.

FIG. 10 is a schematic top view illustrating a configuration of an image display device 100 according to an embodiment of the present technology.

FIG. 11 is a schematic top view illustrating a configuration of an image display device 100 according to an embodiment of the present technology.

FIG. 12 is a perspective view and a top view illustrating an example of design of a curved mirror according to an embodiment of the present technology.

FIG. 13 is a schematic top view illustrating a configuration of an image display device 100 according to an embodiment of the present technology.

FIG. 14 is a schematic top view illustrating a configuration of an image display device according to a comparative example of the present technology.

FIG. 15 is a schematic side view illustrating characteristics of a diffractive element.

### MODE FOR CARRYING OUT THE INVENTION

Hereinafter, preferred modes for implementing the present technology will be described. The embodiments described below show one example of a representative embodiment of the present technology, and do not cause the scope of the present technology to be narrowly interpreted. Multiple embodiments may be combined. Furthermore, the schematic views are not necessarily strictly illustrated.

The present technology will be described in the following order.
1. First embodiment of present technology (Example 1 of light source device)
(1) Overview
(2) Description of present embodiment
2. Second embodiment of present technology (Example 2 of light source device)
3. Third embodiment of present technology (Example 3 of light source device)
4. Fourth embodiment of present technology (Example 4 of light source device)
5. Fifth embodiment of present technology (Example 5 of light source device)
6. Sixth embodiment of present technology (Example 1 of image display device)
7. Seventh embodiment of present technology (Example 2 of image display device)
8. Eighth embodiment of present technology (Example 3 of image display device)

### 1. First Embodiment of Present Technology (Example 1 of Light Source Device)

[(1) Overview]

The present technology relates to a technology for allowing a user to visually recognize an image by projecting image light onto a retina of the user. Conventionally, a diffractive element is used to expand an eye-box as in, for example, Patent Document 1.

Problems in using the diffractive element will be described with reference to FIGS. 14 and 15. FIG. 14 is a schematic top view illustrating a configuration of an image display device according to a comparative example of the present technology. FIG. 15 is a schematic side view illustrating characteristics of a diffractive element.

As illustrated in FIG. 14, an image display device 90 as a comparative example according to the present technology includes a light source unit 91, a diffractive element 92, and a lens 93. The diffractive element 92 diffracts and emits a part of incident light. As a result, the lens 93 on which image light of a plurality of optical paths is incident can project the image light of the plurality of optical paths to a pupil of a user. As a result, the eye-box can be enlarged.

As illustrated in FIG. 15, a plurality of light transmission units 921 is periodically arranged at a predetermined pitch on an incident side of the diffractive element 92. As the number of the light transmission units 921 on which image light is incident increases, elementary waves individually emitted from the plurality of light transmission units 921 intensify each other through interference. As a result, diffraction efficiency of the diffractive element 92 with respect to incident light is improved. That is, in order to improve the diffraction efficiency, a dimensional relationship between a beam diameter of the incident light and a pitch of the diffractive element needs to be sufficiently optimized.

In the technology of projecting image light onto a retina of a user, the diffractive element 92 is generally arranged at a beam waist of image light emitted from the light source unit. Since the beam diameter decreases at the beam waist, the number of light transmission units 921 decreases. As a result, scattered light L9 increases, and the diffraction efficiency decreases. As a result, there is a problem that an optical loss increases and a resolution of the image decreases.

There has also been proposed a technology in which a diffractive element is arranged at a position shifted from a beam waist of image light, but it is impossible to eliminate an optical loss as long as the diffractive element is used. Furthermore, it is considered effective to increase the number of light transmission units 921 by making the pitch very fine, but it is technically difficult.

Moreover, in a case where the diffractive element is used, there is also a problem that downsizing of the image display device becomes difficult. This point will be described with reference to FIG. 14 again. Since an angle at which the diffractive element 92 can diffract is limited, it is necessary to increase a diameter of the lens 93 or to increase a distance F between the lens 93 and the pupil, in order to expand the eye-box. As a result, downsizing of the image display device 90 becomes difficult.

### (2) Description of the Present Embodiment

A light source device according to an embodiment of the present technology includes at least a projection optical system configured to branch light emitted from a light source unit into light in a plurality of directions and emit the light, in which the projection optical system emits the light in the plurality of directions toward an eyepiece optical unit configured to receive light emitted from the projection optical system and emit the light to a retina of a user.

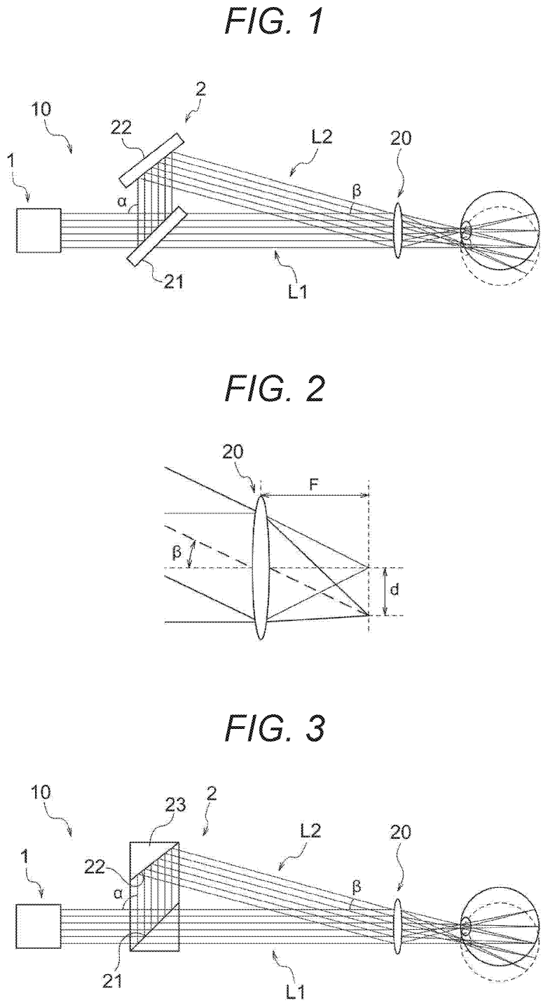

A configuration of the light source device according to an embodiment of the present technology will be described with reference to FIG. 1. FIG. 1 is a schematic top view illustrating a configuration of a light source device 10 according to an embodiment of the present technology.

As illustrated in FIG. 1, the light source device 10 according to an embodiment of the present technology includes at least a projection optical system 2 configured to branch light emitted from a light source unit 1 into light in a plurality of directions and emit the light. The projection optical system 2 emits the light in the plurality of directions toward an eyepiece optical unit 20. The light emitted from the projection optical system 2 includes image light. The eyepiece optical unit 20 receives light emitted from the projection optical system 2 and emits the light to a retina of a user.

The projection optical system 2 does not use a diffractive element. Therefore, the present technology can prevent a reduction in a resolution of an image due to generation of scattered light, and can provide a high-resolution image to a user.

Moreover, individual angles of the light in the plurality of directions emitted from the projection optical system 2 can be freely designed. Therefore, according to the present technology, it is possible to downsize the device by reducing a diameter of a lens of the eyepiece optical unit 20 or reducing a distance between the lens and the pupil.

Furthermore, light in at least two directions among the light in the plurality of directions emitted from the projection optical system 2 is emitted to the same retina. This configuration enables enlargement of the eye-box. By the enlargement of the eye-box, the user can appropriately view the image even if a position of the pupil, the eyepiece optical unit 20, the light source unit 1, or the like changes.

Note that these effects similarly occur in other embodiments described later. Therefore, in the description of other embodiments, another description of the effects may be omitted.

A configuration of the projection optical system 2 is not particularly limited, as long as light emitted from the light source unit 1 can be branched into light in a plurality of directions and emitted. FIG. 1 illustrates an example of a configuration of the projection optical system 2. The projection optical system 2 has: a light branching unit 21 configured to branch light emitted from the light source unit 1 into light in a plurality of directions; and a light reflecting unit 22 configured to reflect light in at least one direction among the light in the plurality of directions branched by the light branching unit 21.

The light branching unit 21 can have, for example, a half mirror. The half mirror can transmit and/or reflect incident light. As a result, light emitted from the light source unit 1 is branched into light in a plurality of directions by the half mirror. The half mirror can be manufactured at a lower cost than a complicated branching element.

The light reflecting unit 22 can have, for example, a mirror. As a result, light in at least one direction among the light in the plurality of directions branched by the light branching unit 21 is reflected by the mirror.

An operation of the light source device 10 will be described. The light source unit 1 emits parallel light. The parallel light may be, for example, laser light.

The light branching unit 21 branches light emitted from the light source unit 1 into light in a plurality of directions by transmitting and/or reflecting the light. In the present embodiment, the light branching unit 21 emits light of a first optical path L1 toward the eyepiece optical unit 20 by transmitting a part of light emitted from the light source unit 1. Furthermore, the light branching unit 21 emits light of a second optical path L2 toward the light reflecting unit 22 by reflecting a part of light emitted from the light source unit 1 at an angle α. Note that the number of optical paths branched by the light branching unit 21 is not particularly limited.

The light reflecting unit 22 reflects the light of the second optical path L2, which is light in at least one direction among the light in the plurality of directions branched by the light branching unit 21. The reflected light of the second optical path L2 travels toward the eyepiece optical unit 20 at an angle different from that of the first optical path L1.

An optical path in the vicinity of the eyepiece optical unit 20 will be described with reference to FIG. 2. FIG. 2 is a schematic top view illustrating an optical path in the vicinity of the eyepiece optical unit 20 according to an embodiment of the present technology.

As illustrated in FIG. 2, light of the first optical path L1 is incident on a surface of the eyepiece optical unit 20, for example, in a normal direction. The light of the first optical path L1 is focused at a position of a focal length F, which is a position near a pupil, and is projected onto a retina.

Furthermore, light of the second optical path L2 is incident on the eyepiece optical unit 20 in a direction of an angle β with respect to the first optical path L1. The light of the second optical path L2 is focused at a position separated from the focal point of the first optical path L1 by a distance d in a horizontal direction with respect to the surface of the eyepiece optical unit 20, and is projected onto the retina. The distance d can be calculated according to the following Equation (1) using the focal length F and the incident angle β of the second optical path L2.

d=F×tan(β) (1)

According to the present technology, the user can appropriately view the image even in a case where the pupil of the user moves by the distance d. That is, according to the present technology, the eye-box of the user can be enlarged.

The focal length F, the incident angle β, and the distance d can be appropriately designed in accordance with individual differences of users, specifications of the light source unit 1, and the like. For example, when the focal length F is 35 mm and the incident angle β is 4.9 deg, the distance d is 3.00 mm. At this time, it has been verified that it is possible to contribute to enlargement of the eye-box, provision of high-resolution image, and downsizing of the device.

Note that the number of focal points focused by the eyepiece optical unit 20 is not particularly limited. Furthermore, in the present embodiment, the focal point of the first optical path L1 and the focal point of the second optical path L2 are individually arranged at positions separated in a left-right direction as viewed from the light source unit 1, but may be arranged at positions separated in an up-down direction, for example.

Meanwhile, when effective light reflected by the light reflecting unit 22 is emitted to the light branching unit 21 again, stray light may be generated. The effective light refers to image light including an image to be viewed by the user. When stray light is generated, for example, there is a possibility that contrast of an image is reduced or a color of the image is unintentionally changed. As a result, quality of the image is deteriorated.

Therefore, the light reflecting unit 22 according to an embodiment of the present technology may have an angular characteristic in which image light reflected by the light reflecting unit 22 is not emitted to the light branching unit 21. As a result, since generation of stray light can be prevented, the light source device 10 can provide a high-quality image.

### 2. Second Embodiment of Present Technology (Example 2 of Light Source Device)

A projection optical system according to an embodiment of the present technology may have a prism. This point will be described with reference to FIG. 3. FIG. 3 is a schematic top view illustrating a configuration of a light source device 10 according to an embodiment of the present technology.

As illustrated in FIG. 3, a projection optical system 2 according to an embodiment of the present technology has a prism 23. The prism 23 has: a light branching unit 21 configured to branch light emitted from a light source unit 1 into light in a plurality of directions; and a light reflecting unit 22 configured to reflect light in at least one direction among the light in the plurality of directions branched by the light branching unit 21.

At a time of manufacturing the prism 23, after individual angles of the light branching unit 21 and the light reflecting unit 22 are adjusted, the light branching unit 21 and the light reflecting unit 22 are integrally manufactured as the prism 23. Therefore, manufacturing becomes easier.

Furthermore, since each of the light branching unit 21 and the light reflecting unit 22 according to another embodiment is bonded by, for example, an adhesive or the like, an optical path may change due to a change with time, a change in temperature, or the like. Whereas, in the present embodiment, since the light branching unit 21 and the light reflecting unit 22 each are integrally formed, the change in the optical path can be prevented. Moreover, in the present embodiment, since an adhesive or the like is not used, an area of transmission and/or reflection can be increased.

### 3. Third Embodiment of Present Technology (Example 3 of Light Source Device)

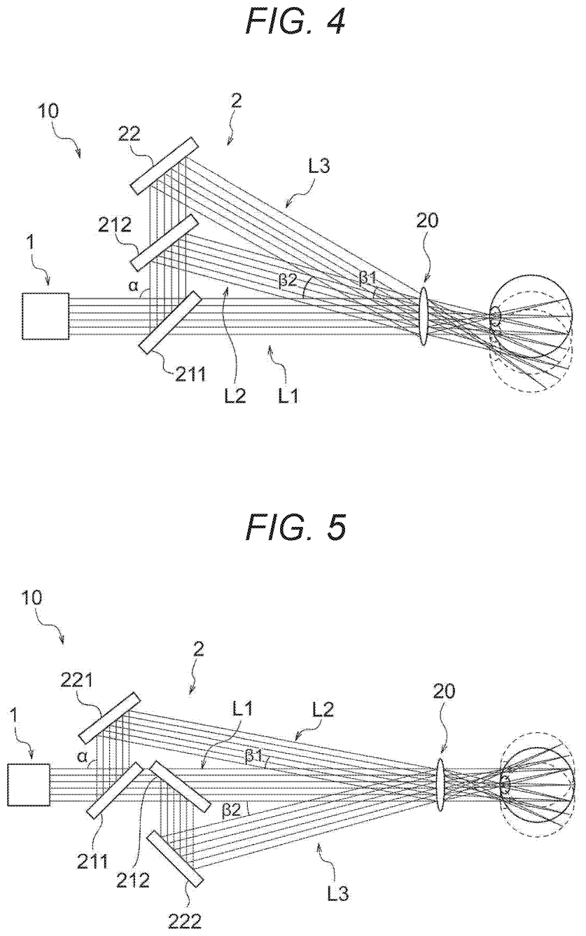

A projection optical system according to an embodiment of the present technology may have a plurality of light branching units. This point will be described with reference to FIG. 4. FIG. 4 is a schematic top view illustrating a configuration of a light source device 10 according to an embodiment of the present technology.

As illustrated in FIG. 4, a projection optical system 2 according to an embodiment of the present technology has: a first light branching unit 211 configured to branch light emitted from a light source unit 1 into light in a plurality of directions; a second light branching unit 212 configured to branch light in at least one direction among the light in the plurality of directions branched by the first light branching unit 211 into light in a plurality of directions; and a light reflecting unit 22 configured to reflect light in at least one direction among the light in the plurality of directions branched by the second light branching unit 212. Note that the number, arrangement positions, and the like of the light branching units are not particularly limited. This point similarly applies to other embodiments.

An operation of the light source device 10 will be described. The first light branching unit 211 branches light emitted from the light source unit 1 into light in a plurality of directions by transmitting and/or reflecting the light. In the present embodiment, the first light branching unit 211 emits light of a first optical path L1 toward an eyepiece optical unit 20 by transmitting a part of light emitted from the light source unit 1. Furthermore, the first light branching unit 211 emits light of a second optical path L2 toward the second light branching unit 212 by reflecting a part of light emitted from the light source unit 1 at an angle α.

The second light branching unit 212 branches light emitted from the first light branching unit 211 into light in a plurality of directions by transmitting and/or reflecting the light. In the present embodiment, the second light branching unit 212 emits light of the second optical path L2 toward the eyepiece optical unit 20 by reflecting a part of the light emitted from the first light branching unit 211. The light of the second optical path L2 travels toward the eyepiece optical unit 20 at an angle different from that of the first optical path L1. Furthermore, the second light branching unit 212 emits light of a third optical path L3 toward the light reflecting unit 22 by transmitting a part of light emitted from the first light branching unit 211.

The light reflecting unit 22 reflects the light of the third optical path L3, which is light in at least one direction among the light in the plurality of directions branched by the second light branching unit 212. The reflected light of the third optical path L3 travels toward the eyepiece optical unit 20 at an angle different from each of the first optical path L1 and the second optical path L2.

The light of the first optical path L1 is incident on a surface of the eyepiece optical unit 20, for example, in a normal direction. The light of the first optical path L1 is focused at a position near a pupil and projected onto a retina.

The light of the second optical path L2 is incident on the eyepiece optical unit 20 in a direction of an angle β1 with respect to the first optical path L1. The light of the second optical path L2 is focused at a position separated from the focal point of the first optical path L1 by a predetermined distance in a horizontal direction with respect to the surface of the eyepiece optical unit 20, and is projected onto the retina.

The light of the third optical path L3 is incident on the eyepiece optical unit 20 in a direction of an angle β2 with respect to the first optical path L1. The angle β2 is greater than the angle β1. Therefore, the light of the third optical path L3 is focused at a position further away from the focal point of the first optical path L1 by a predetermined distance in the horizontal direction with respect to the surface of the eyepiece optical unit 20, and is projected onto the retina.

According to the present technology, the eye-box is further expanded as compared with the embodiment in which there is one light branching unit.

### 4. Fourth Embodiment of Present Technology (Example 4 of Light Source Device)

A projection optical system according to an embodiment of the present technology may have a plurality of light branching units and a plurality of light reflecting units. This point will be described with reference to FIG. 5. FIG. 5 is a schematic top view illustrating a configuration of a light source device 10 according to an embodiment of the present technology.

As illustrated in FIG. 5, a projection optical system 2 according to an embodiment of the present technology has: a first light branching unit 211 configured to branch light emitted from a light source unit 1 into light in a plurality of directions; a second light branching unit 212 configured to branch light in at least one direction among the light in the plurality of directions branched by the first light branching unit 211 into light in a plurality of directions; a first light reflecting unit 221 configured to reflect light in at least one direction among the light in the plurality of directions branched by the first light branching unit 211; and a second light reflecting unit 222 configured to reflect light in at least one direction among the light in the plurality of directions branched by the second light branching unit 212. Note that the number, an arrangement position, and the like of each of the light branching units and the light reflecting units are not particularly limited. This point similarly applies to other embodiments.

An operation of the light source device 10 will be described. The first light branching unit 211 branches light emitted from the light source unit 1 into light in a plurality of directions by transmitting and/or reflecting the light. In the present embodiment, the first light branching unit 211 emits light of a first optical path L1 toward the second light branching unit 212 and an eyepiece optical unit 20 by transmitting a part of light emitted from the light source unit 1. Furthermore, the first light branching unit 211 emits light of a second optical path L2 toward the first light reflecting unit 221 by reflecting a part of light emitted from the light source unit 1 at an angle α.

The second light branching unit 212 branches light emitted from the first light branching unit 211 into light in a plurality of directions by transmitting and/or reflecting the light. In the present embodiment, the second light branching unit 212 emits light of the first optical path L1 toward the eyepiece optical unit 20 by transmitting a part of light emitted from the first light branching unit 211. Furthermore, the second light branching unit 212 emits light of a third optical path L3 toward the second light reflecting unit 222 by reflecting a part of light emitted from the first light branching unit 211.

The first light reflecting unit 221 reflects the light of the second optical path, which is light in at least one direction among the light in the plurality of directions branched by the first light branching unit 211. The reflected light of the second optical path travels toward the eyepiece optical unit 20 at an angle different from that of the first optical path L1.

The second light reflecting unit 222 reflects the light of the third optical path L3, which is light in at least one direction among the light in the plurality of directions branched by the second light branching unit 212. The reflected light of the third optical path L3 travels toward the eyepiece optical unit 20 at an angle different from the first optical path L1 and the second optical path L2.

The light of the first optical path L1 is incident on a surface of the eyepiece optical unit 20, for example, in a normal direction. The light of the first optical path L1 is focused at a position near a pupil and projected onto a retina.

The light of the second optical path L2 is incident on the eyepiece optical unit 20 in a direction of an angle β1 with respect to the first optical path L1. The light of the second optical path L2 is focused at a position separated from the focal point of the first optical path L1 by a predetermined distance in a horizontal direction with respect to the surface of the eyepiece optical unit 20, and is projected onto the retina.

The light of the third optical path L3 is incident on the eyepiece optical unit 20 in a direction of an angle β2 with respect to the first optical path L1. For example, when the angle β1 is positive, the angle β2 is negative. Therefore, the light of the third optical path L3 is focused at a position separated by a predetermined distance in a horizontal direction opposite to the focal point of the second optical path L2, and is projected onto the retina.

According to the present technology, the eye-box is further expanded as compared with the embodiment in which there is one light branching unit.

### 5. Fifth Embodiment of Present Technology (Example 5 of Light Source Device)

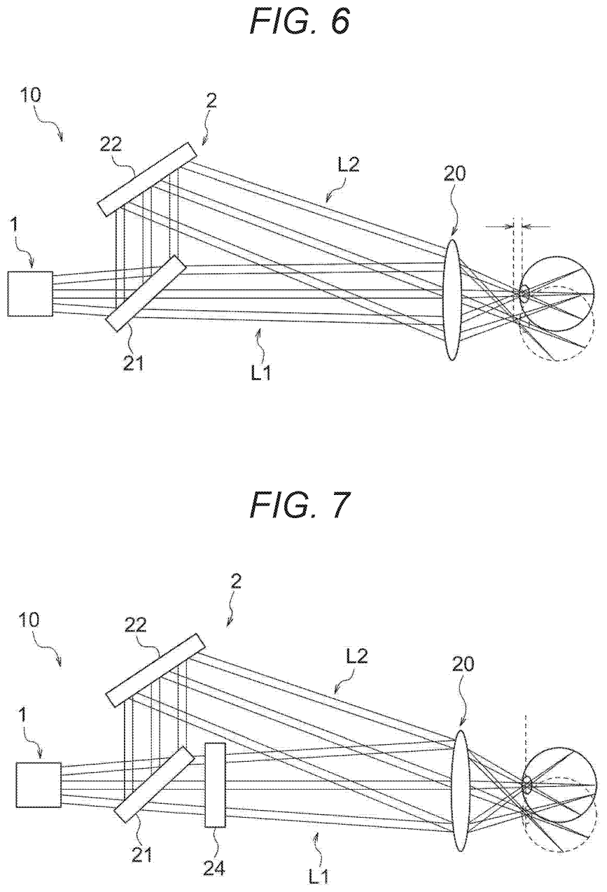

A light source unit 1 according to an embodiment of the present technology may emit divergent light. However, in a case where the light source unit 1 emits divergent light, a position of a focal point focused by an eyepiece optical unit 20 may be shifted. This point will be described with reference to FIG. 6. FIG. 6 is a schematic top view illustrating a configuration of an image display device according to a comparative example of the present technology.

As illustrated in FIG. 6, in a case where the light source unit 1 emits divergent light, an optical path length of a first optical path L1 may be different from an optical path length of a second optical path L2. As a result, a position of a focal point related to the first optical path L1 and a position of a focal point related to the second optical path L2 are shifted in a normal direction with respect to a surface of the eyepiece optical unit 20. As a result, there arises a problem that enlargement of the eye-box becomes insufficient.

Therefore, the projection optical system according to an embodiment of the present technology may further have an optical path length correction unit configured to correct an optical path length. This point will be described with reference to FIG. 7. FIG. 7 is a schematic top view illustrating a configuration of a light source device 10 according to an embodiment of the present technology.

As illustrated in FIG. 7, a projection optical system 2 further has an optical path length correction unit 24 configured to correct an optical path length. As a result, even in the configuration in which the light source unit 1 emits divergent light, it is possible to prevent a position of a focal point related to the first optical path L1 and a position of a focal point related to the second optical path L2 from being shifted in the normal direction with respect to the surface of the eyepiece optical unit 20. As a result, the eye-box is sufficiently enlarged.

A material of the optical path length correction unit 24 is not particularly limited, as long as a refractive index different from a refractive index of air is provided. As an example, glass having a refractive index higher than that of air can be used as a material of the optical path length correction unit 24.

In the present embodiment, the optical path length correction unit 24 is disposed on the first optical path L1 connecting a light branching unit 21 and the eyepiece optical unit 20, but the position where the optical path length correction unit 24 is disposed is not particularly limited. For example, the optical path length correction unit 24 may be disposed on the second optical path L2 connecting a light reflecting unit 22 and the eyepiece optical unit 20.

Note that the optical path length correction unit 24 can also be used in a configuration in which the light source unit 1 emits parallel light. In a configuration in which the light source unit 1 emits parallel light, the optical path length correction unit 24 can prevent a position of a beam waist related to the first optical path L1 and a position of a beam waist related to the second optical path L2 from being shifted in the normal direction with respect to the surface of the eyepiece optical unit 20.

### 6. Sixth Embodiment of Present Technology (Example 1 of Image Display Device)

An image display device according to an embodiment of the present technology includes the light source device according to another embodiment described above, and an eyepiece optical unit configured to receive light emitted from the light source device and emit the light to a retina of a user.

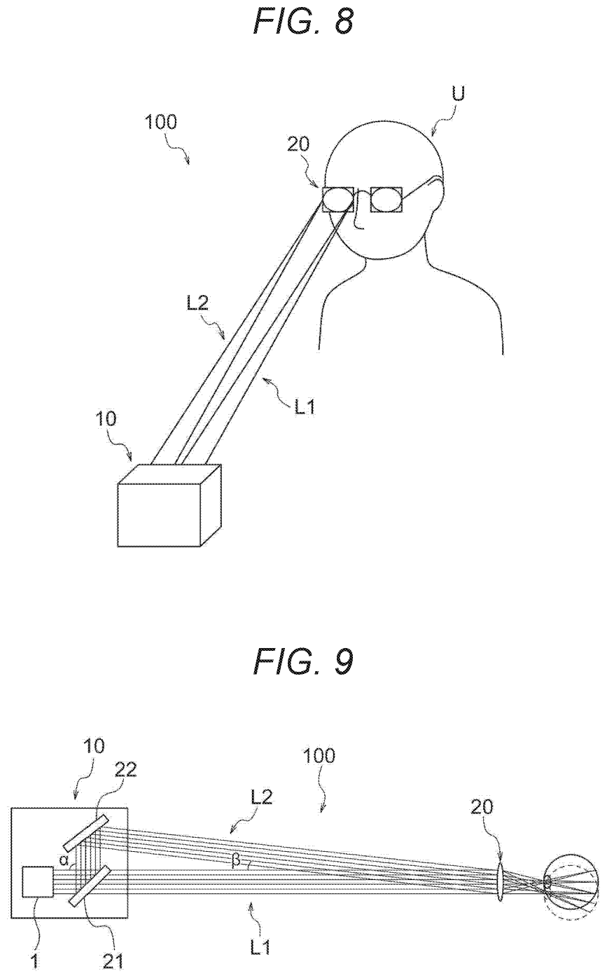

A configuration of the image display device according to an embodiment of the present technology will be described with reference to FIGS. 8 and 9. FIG. 8 is a schematic perspective view illustrating a usage example of an image display device 100 according to an embodiment of the present technology. FIG. 9 is a schematic top view illustrating a configuration of the image display device 100 according to an embodiment of the present technology.

As illustrated in FIG. 9, the image display device 100 according to an embodiment of the present technology includes a light source device 10 and an eyepiece optical unit 20 configured to receive light emitted from the light source device 10 and emit the light to a retina of a user.

The light source device 10 emits light in a plurality of directions toward the eyepiece optical unit 20. In the present embodiment, the light source device 10 emits light of a first optical path L1 and light of a second optical path L2 toward the eyepiece optical unit 20.

The eyepiece optical unit 20 can be mounted on a head part of a user U. An embodiment of the eyepiece optical unit 20 may be, for example, glasses, goggles, a helmet, or the like.

The eyepiece optical unit 20 is separated from the light source device 10. A lens included in the eyepiece optical unit 20 is disposed on an optical path of light emitted from the light source device 10, and is disposed in front of the eyes of the user U.

Image light emitted from the light source device 10 reaches the eyes of the user U through the lens. The image light passes through a pupil of the user U and forms an image on a retina.

Conventionally, there is a problem that myopia, hyperopia, or the like occurs when a focus adjustment function of a crystalline lens serving as a lens is deteriorated. However, in the present technology, since an image is directly projected onto the retina, the user can visually recognize a clear image. An effect is provided in which a visual field is easily secured, and an image is difficult to disappear, even in a case where the pupil or the lens is displaced. Moreover, according to the present technology, by the light source device 10 projecting light in a plurality of directions toward the eyepiece optical unit 20, the eye-box is enlarged.

Moreover, according to the present technology, a focal length, which is a distance between the lens of the eyepiece optical unit 20 and the pupil, can be reduced, and a diameter of the lens can be reduced. Therefore, the present technology can contribute to downsizing of the eyepiece optical unit 20.

As a technology for forming an image on a retina, for example, a Maxwell optical system, a laser scanning optical system, or the like can be used. The Maxwell optical system is a system that passes image light through a center of a pupil to form an image on the retina. The laser scanning optical system is a method of scanning red light, green light, and blue light at high speed to write an image on the retina. The laser scanning optical system is not affected by the resolution of the image, and can bring the image as close as possible to the human field of view.

The eyepiece optical unit 20 does not need to include the projection optical system. Furthermore, the eyepiece optical unit 20 does not need to include, for example, the projection optical system, a power supply, and a device driven by electric power, which are components necessary for projecting image light. This configuration enables reduction in size and/or weight of the eyepiece optical unit 20. As a result, a burden on the user is reduced.

Furthermore, since the components necessary for projecting image light do not need to be included, a manufacturing cost of the eyepiece optical unit 20 can be reduced, and a degree of freedom of design of the eyepiece optical unit 20 is increased.

Note that the image display device according to the present technology is not limited to the embodiment in which the light source device 10 and the eyepiece optical unit 20 are separated as in the present embodiment. The image display device according to the present technology may be an embodiment in which the light source device 10 and the eyepiece optical unit 20 are integrated, such as a head-mounted display, for example.

Image light emitted from the light source device 10 is preferably coherent light. The coherent light has a characteristic that light beams are parallel and difficult to spread. As a result, an effect is provided in which an image is easily focused.

Note that image light emitted from the light source device 10 need not be ideal coherent light. The image light may be, for example, laser light. Laser light is as close as possible to coherent light, and has a characteristic that light beams are parallel and difficult to spread. As a result, an effect is provided in which an image is easily focused. This can be achieved, for example, by using a semiconductor laser (LD: Laser Diode) for the light source unit 1.

According to a preferred embodiment of the present technology, for example, a light emission diode (LED) or the like may be used for the light source unit 1.

According to a preferred embodiment of the present technology, the light source device 10 may emit different image light onto each of both eyes of the user. For example, the light source device 10 can project different image light onto each of both eyes on the basis of a parallax between both eyes of the user. As a result, for example, the user can recognize a three-dimensional position of the presented image, for example, by binocular vision. For example, a three-dimensional virtual image appears in the outside scene the user is viewing.

### 7. Seventh Embodiment of Present Technology (Example 2 of Image Display Device)

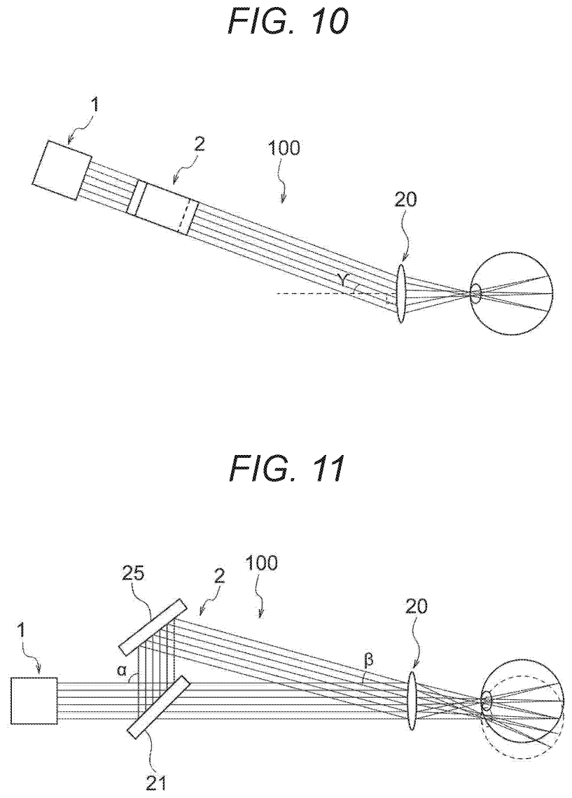

An eyepiece optical unit according to an embodiment of the present technology can have a holographic optical element lens. A configuration of an image display device when the eyepiece optical unit has the holographic optical element lens will be described with reference to FIG. 10. FIG. 10 is a schematic top view illustrating a configuration of an image display device 100 according to an embodiment of the present technology.

As illustrated in FIG. 10, since an eyepiece optical unit 20 has a holographic optical element lens, a light source device 10 can be disposed in a direction inclined with respect to a normal direction of a surface of the holographic optical element lens. In the present embodiment, the light source device 10 is arranged in a direction inclined by an angle γ with respect to the normal direction of the surface of the holographic optical element lens.

This arrangement makes it possible to prevent a front of the user's eyes from being blocked by the light source device 10. Furthermore, when a display screen (not illustrated) is arranged in front of the eyes of the user, an image displayed on the display screen and an image projected onto a retina of the user can be displayed in a superimposed manner.

The eyepiece optical unit 20 may preferably have a film-shaped holographic optical element, more preferably a transparent film-shaped holographic optical element. Desired optical characteristics can be imparted to the holographic optical element by techniques known in the technical field. As the holographic optical element, a commercially available holographic optical element may be used, or the holographic optical element may be manufactured by a technique known in the technical field.

For example, the film-shaped holographic optical element can be laminated on one surface of a lens of the eyepiece optical unit 20. The surface may be a surface on the outside scene side or a surface on the eyeball side. The image display device 100 according to an embodiment of the present technology can be used by attaching the film-shaped holographic optical element to a lens appropriately selected by a user or a person skilled in the art. Therefore, a range of selection of the eyepiece optical unit 20 that can be adopted in the present technology is very wide.

Note that, since the eyepiece optical unit 20 is only required to bend light, for example, a generally used convex lens or the like may be used.

### 8. Eighth Embodiment of Present Technology (Example 3 of Image Display Device)

When the light source device 10 is arranged in a direction inclined with respect to the normal direction of the surface of the holographic optical element lens, there is a possibility that distortion of an image occurs. For example, a rectangular image may be distorted into a parallelogram image.

In order to solve this problem, a projection optical system according to an embodiment of the present technology can further have a distortion correction unit configured to correct distortion of an image. This point will be described with reference to FIG. 11. FIG. 11 is a schematic top view illustrating a configuration of an image display device 100 according to an embodiment of the present technology.

As illustrated in FIG. 11, a projection optical system 2 according to an embodiment of the present technology further has a distortion correction unit 25 configured to correct distortion of an image. As a result, even if a light source device 10 is arranged in a direction inclined with respect to a normal direction of a surface of a holographic optical element lens, a user can see an image in which distortion is corrected.

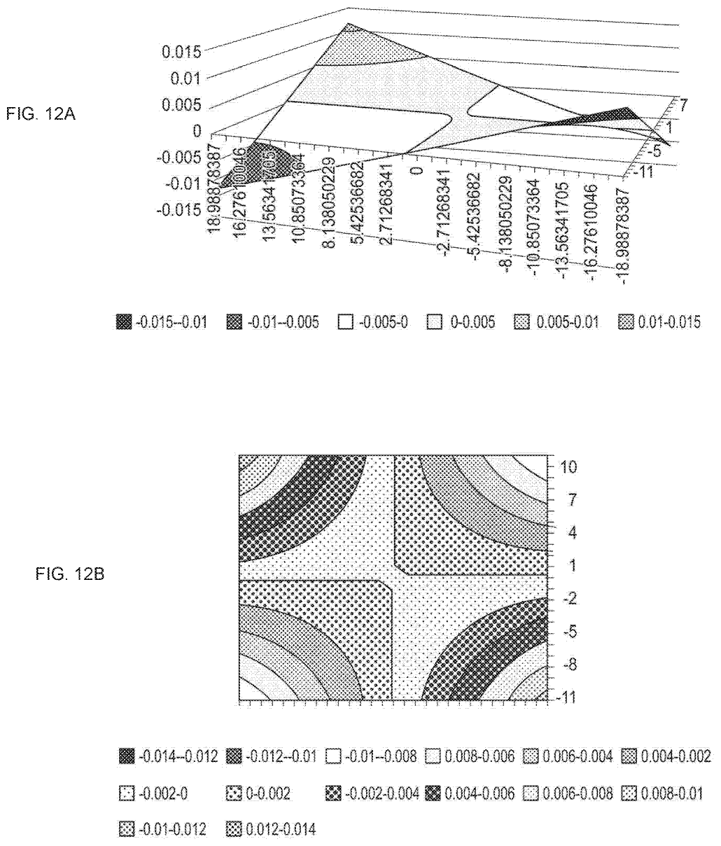

As an embodiment, the distortion correction unit 25 can have a curved mirror. In the curved mirror, an angle of a reflecting surface is designed in order to correct distortion of an image. An example of design of the curved mirror will be described with reference to FIG. 12. FIG. 12A is a perspective view illustrating an example of the design of the curved mirror according to an embodiment of the present technology. FIG. 12B is a top view illustrating an example of the design of the curved mirror according to an embodiment of the present technology.

FIG. 12 illustrates contour lines. By designing the curved mirror as illustrated in FIG. 12, a parallelogram image can be corrected to a rectangle image.

As another embodiment, the distortion correction unit 25 can have a free-form surface lens. In the free-form surface lens, an angle of a surface is designed in order to correct distortion of an image.

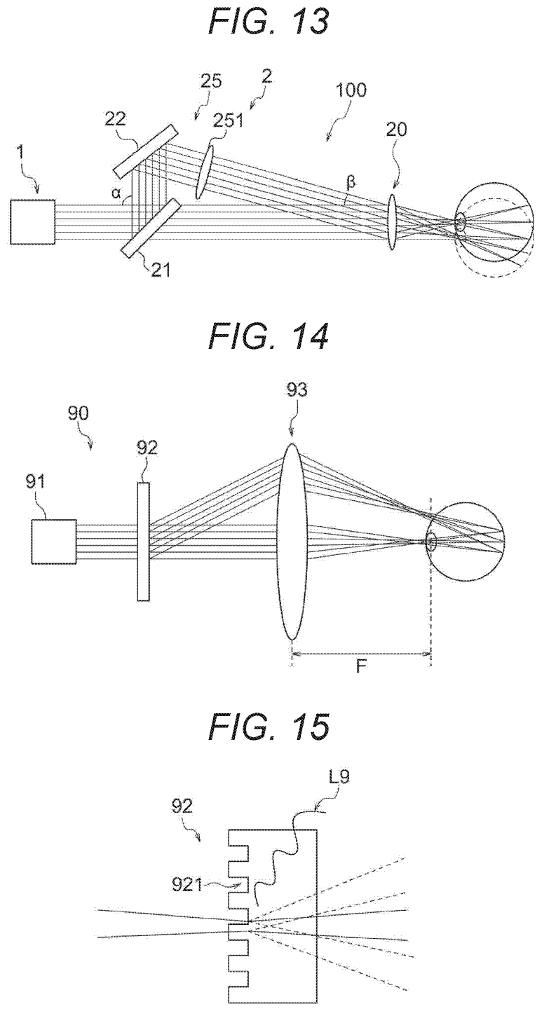

A configuration of an image display device when the distortion correction unit 25 has the free-form surface lens will be described with reference to FIG. 13. FIG. 13 is a schematic top view illustrating a configuration of the image display device 100 according to an embodiment of the present technology.

As illustrated in FIG. 13, the distortion correction unit 25 according to an embodiment of the present technology has a free-form surface lens 251. The free-form surface lens 251 can be disposed, for example, on an optical path connecting a light reflecting unit 22 and an eyepiece optical unit 20. As a result, a user can view an image in which distortion is corrected.

In addition to this, the configurations described in the above-described embodiments can be selected or changed as appropriate to other configurations without departing from the gist of the present technology.

Note that the effects described in this specification are merely examples and are not limited, and other effects may also be present.

Note that the following configurations can be used for the present technology.

[1]

A light source device including
at least a projection optical system configured to branch light emitted from a light source unit into light in a plurality of directions and emit the light, in which
the projection optical system emits the light in the plurality of directions toward an eyepiece optical unit configured to receive light emitted from the projection optical system and emit the light to a retina of a user.

[2]

The light source device according to [1], in which
light in at least two directions among light in a plurality of directions emitted from the projection optical system is emitted to a same retina.

[3]

The light source device according to [1] or [2], in which
the projection optical system has:
a light branching unit configured to branch light emitted from the light source unit into light in a plurality of directions; and
a light reflecting unit configured to reflect light in at least one direction among the light in the plurality of directions branched by the light branching unit.

[4]

The light source device according to [3], in which
the light branching unit has a half mirror.

[5]

The light source device according to any one of [1] to [4], in which
the projection optical system has a prism.

[6]

The light source device according to any one of [1] to [5], in which
the projection optical system has a plurality of light branching units.

[7]

The light source device according to any one of [1] to [6], in which
the projection optical system has a plurality of light branching units and a plurality of light reflecting units.

[8]

The light source device according to any one of [3] to [7], in which
the light reflecting unit has an angular characteristic in which image light reflected by the light reflecting unit is not emitted to the light branching unit.

[9]

The light source device according to any one of [1] to [8], in which
the projection optical system further has an optical path length correction unit configured to correct an optical path length.

[10]

An image display device including:
the light source device according to any one of [1] to [9]; and
an eyepiece optical unit configured to receive light emitted from the light source device and emit the light to a retina of a user.

[11]

The image display device according to [10], in which
the eyepiece optical unit has a holographic optical element lens.

[12]

The image display device according to [11], in which
the light source device is disposed in a direction inclined with respect to a normal direction of a surface of the holographic optical element lens.

[13]

The image display device according to any one of [10] to

[12], in which
the projection optical system further has a distortion correction unit configured to correct distortion of an image.

[14]

The image display device according to [13], in which
the distortion correction unit has a curved mirror.

[15]

The image display device according to [13] or [14], in which
the distortion correction unit has a free-form surface lens.

### REFERENCE SIGNS LIST

10 Light source device
1 Light source unit
2 Projection optical system
21 Light branching unit
211 First light branching unit
212 Second light branching unit
22 Light reflecting unit
221 First light reflecting unit
222 Second light reflecting unit
23 Prism
24 Optical path length correction unit
25 Distortion correction unit
251 Free-form surface lens
20 Eyepiece optical unit
100 Image display device

1. A light source device comprising
at least a projection optical system configured to branch light emitted from a light source unit into light in a plurality of directions and emit the light, wherein
the projection optical system emits the light in the plurality of directions toward an eyepiece optical unit configured to receive light emitted from the projection optical system and emit the light to a retina of a user.

2. The light source device according to claim 1, wherein
light in at least two directions among light in a plurality of directions emitted from the projection optical system is emitted to a same retina.

3. The light source device according to claim 1, wherein
the projection optical system has:
a light branching unit configured to branch light emitted from the light source unit into light in a plurality of directions; and
a light reflecting unit configured to reflect light in at least one direction among the light in the plurality of directions branched by the light branching unit.

4. The light source device according to claim 3, wherein
the light branching unit has a half mirror.

5. The light source device according to claim 1, wherein
the projection optical system has a prism.

6. The light source device according to claim 1, wherein
the projection optical system has a plurality of light branching units.

7. The light source device according to claim 1, wherein
the projection optical system has a plurality of light branching units and a plurality of light reflecting units.

8. The light source device according to claim 3, wherein
the light reflecting unit has an angular characteristic in which image light reflected by the light reflecting unit is not emitted to the light branching unit.

9. The light source device according to claim 1, wherein
the projection optical system further has an optical path length correction unit configured to correct an optical path length.

10. An image display device comprising:
the light source device according to claim 1; and
an eyepiece optical unit configured to receive light emitted from the light source device and emit the light to a retina of a user.

11. The image display device according to claim 10, wherein
the eyepiece optical unit has a holographic optical element lens.

12. The image display device according to claim 11, wherein
the light source device is disposed in a direction inclined with respect to a normal direction of a surface of the holographic optical element lens.

13. The image display device according to claim 10, wherein
the projection optical system further has a distortion correction unit configured to correct distortion of an image.

14. The image display device according to claim 13, wherein
the distortion correction unit has a curved mirror.

15. The image display device according to claim 13, wherein
the distortion correction unit has a free-form surface lens.
